(19) United States
(12) Patent Application Publication
(10) Pub. No.: US 2009/0046674 A1
(43) Pub. Date: Feb. 19, 2009

(54) METHOD AND APPARATUS FOR PROVIDING CHANNEL FEEDBACK INFORMATION

(76) Inventors: Chun Yan Gao, Beijing (CN); Mihai Horatiu Enescu, Espoo (FI)

Correspondence Address: DITTHAVONG MORI & STEINER, P.C., 918 Prince St., Alexandria, VA, 22314, US

(21) Appl. No.: 11/840,830

(22) Filed: Aug. 17, 2007

(51) Int. Cl. H04B 7/212

(52) U.S. Cl. 370/337

(57) ABSTRACT

An approach is provided for transmitting channel feedback information. Bandwidth is partitioned into one or more resource groups corresponding to one or more resource units. One or more of the partitions is designated for transmission of a plurality of uplink pilots that specify channel information for the corresponding resource units.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves providing link adaptation using feedback methods to improve link performance.

### SOME EXEMPLARY EMBODIMENTS

Therefore, there is a need for an approach to provide more efficient feedback signaling.

According to one embodiment of the present invention, a method comprises partitioning a bandwidth into one or more resource groups corresponding to one or more resource units. The method also comprises designating one or more of the partitions for transmission of a plurality of uplink pilots that specify channel information for the corresponding resource units.

According to another embodiment of the present invention, an apparatus comprises a processor configured to partition a bandwidth into one or more resource groups corresponding to one or more resource units. The processor is further configured to designate one or more of the partitions for transmission of a plurality of uplink pilots that specify channel information for the corresponding resource units.

According to another embodiment of the present invention, a method comprises receiving one or more uplink pilots from a user equipment, wherein the uplink pilots specify channel information for a plurality of resource units. The method also comprises partitioning a channel bandwidth into a plurality of resource groups corresponding to the resource units, wherein the partitions are utilized for transmission of the uplink pilots.

According to yet another embodiment of the present invention, an apparatus comprises a transceiver configured to receive one or more uplink pilots from a user equipment, wherein the uplink pilots specify channel information for a plurality of resource units. The apparatus also comprises a processor configured to partition a channel bandwidth into a plurality of resource groups corresponding to the resource units, wherein the partitions are utilized for transmission of the uplink pilots.

Still other aspects, features, and advantages of the embodiments of the invention are readily apparent from the following detailed description, simply by illustrating a number of particular embodiments and implementations, including the best mode contemplated for carrying out the embodiments of the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings and in which like reference numerals refer to similar elements and in which:

FIG. 1 is a diagram of a multiple input multiple output (MIMO) system capable of providing closed-loop preceding and beamforming, in accordance with an embodiment of the invention;

FIGS. 2A-2C are diagrams of communication systems having a long-term evolution (LTE) architecture, according to various exemplary embodiments of the invention;

FIGS. 3A and 3B are flowcharts of processes for providing feedback information utilizing, respectively, uplink scheduling bandwidth and downlink scheduling bandwidth, in accordance with an embodiment of the invention;

FIG. 4 is a flowchart of a process for uplink sounding pilot transmission, according to an embodiment of the invention;

FIGS. 5A and 5B are diagrams of frame structures for uplink sounding pilot transmission, in accordance with certain embodiments of the invention;

FIGS. 6A-6F are diagrams of exemplary uplink sounding pilot patterns, according to various embodiments of the invention;

FIG. 7 is a diagram of hardware that can be used to implement an embodiment of the invention; and

FIG. 8 is a diagram of exemplary components of a mobile station capable of operating in the system of FIG. 1, according to an embodiment of the invention.

### DESCRIPTION OF PREFERRED EMBODIMENTS

An apparatus, method, and software for providing feedback information in a multiple input multiple output (MIMO) system are described. In the following description, for the purposes of explanation, numerous specific details are set forth in order to provide a thorough understanding of the invention. It is apparent, however, to one skilled in the art that the invention may be practiced without these specific details or with an equivalent arrangement. In other instances, well-known structures and devices are shown in block diagram form in order to avoid unnecessarily obscuring the invention.

Although the embodiments of the invention are discussed with respect to a wireless network compliant with the Third Generation Partnership Project (3GPP) Long Term Evolution (LTE) architecture, it is recognized by one of ordinary skill in the art that the embodiments of the inventions have applicability to any type of communication system and equivalent functional capabilities.

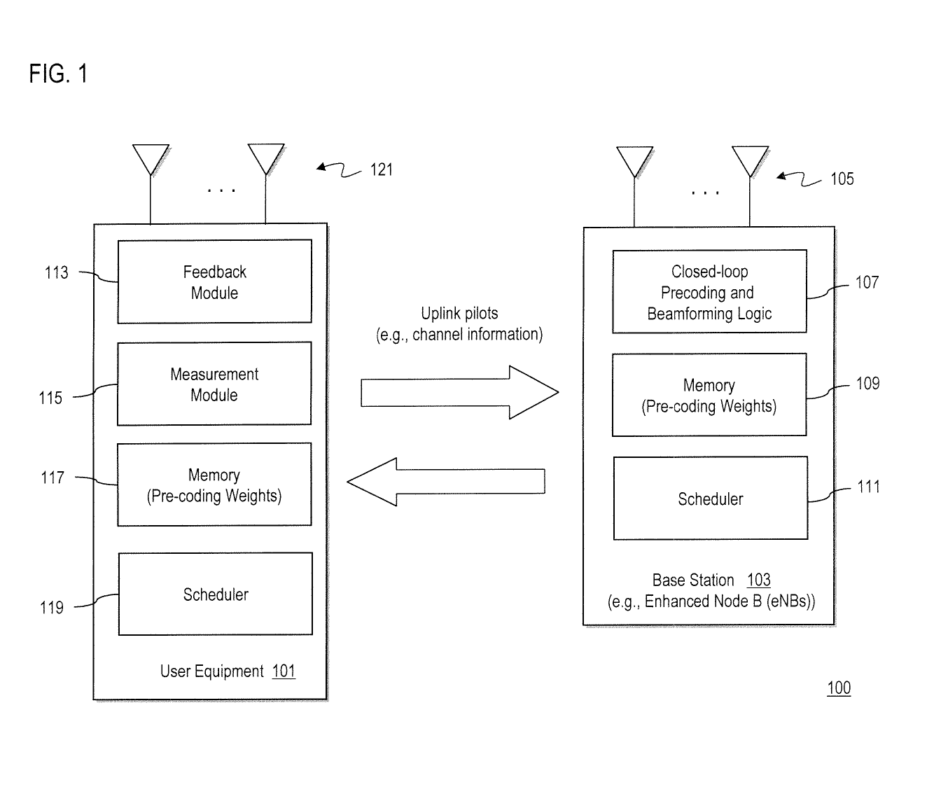

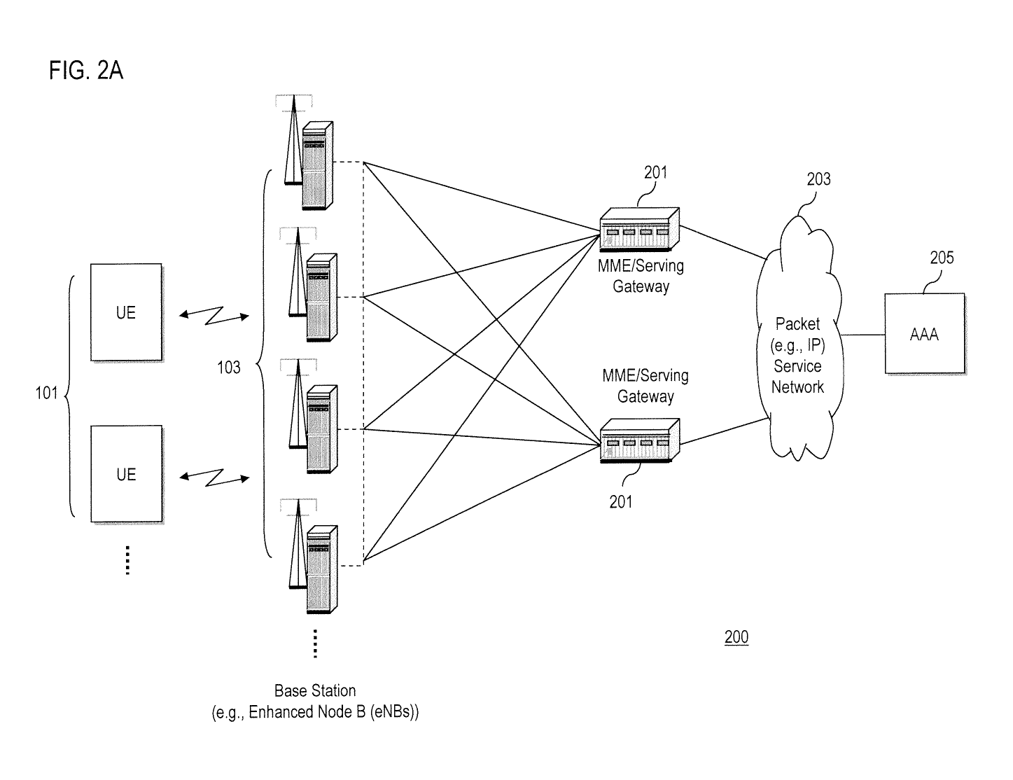

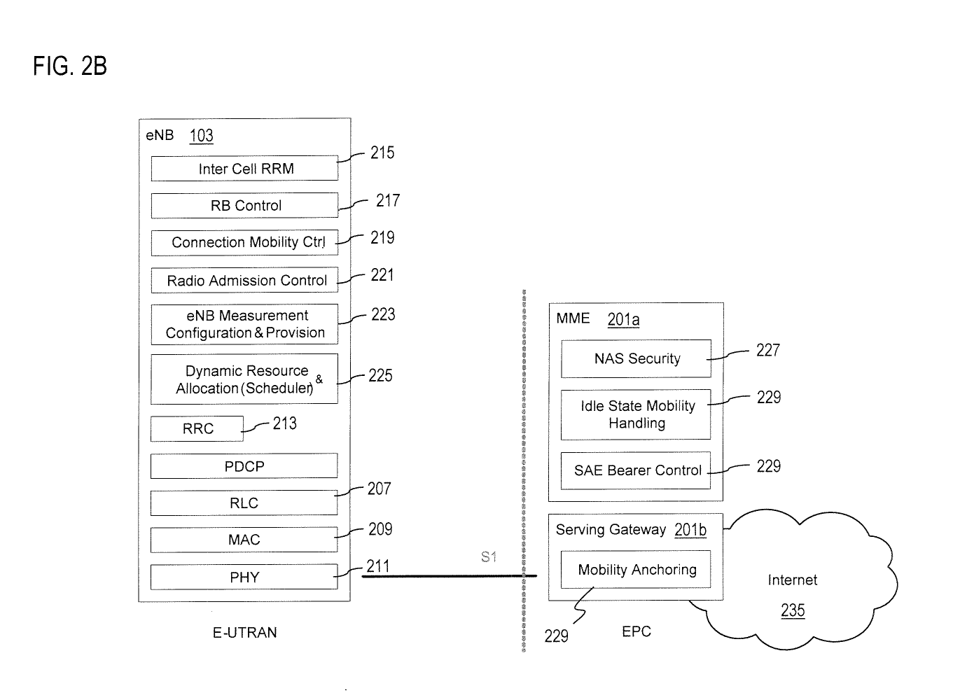

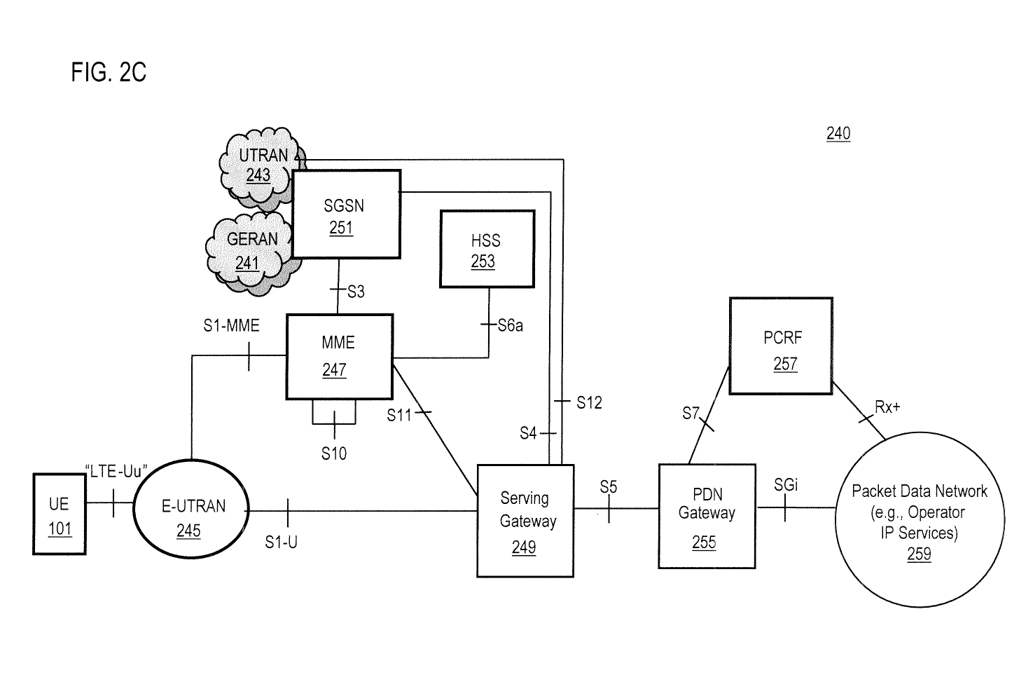

FIG. 1 is a diagram of a multiple input multiple output (MIMO) system capable of providing closed-loop preceding and beamforming, in accordance with an embodiment of the invention. A communication system 100 includes one or more user equipment (UEs) 101 that communicate with a base station (BS) 103, which is part of an access network (not shown). By way of example, the UE 101 can be any type of mobile stations, such as handsets, terminals, stations, units, devices, or any type of interface to the user (such as “wearable” circuitry, etc.). In an exemplary embodiment, the access network is illustrated in FIG. 2A, and operates according to a 3GPP LTE architecture. Under such an architecture, the base station 103 is denoted as an enhanced Node B (eNB), and enables reduced latency, high user data rates, improved system capacity and coverage, as well as reduced cost for the operator or service provider.

According to one embodiment, the system 100 is a multiple input multiple output (MIMO) system. The Node B or eNB 103 may utilize a MIMO antenna system 105 to provide increased data rates and improved coverage and capacity. That is, this arrangement supports the parallel transmission of independent data streams to achieve high data rates. The system 100 provides multiple parallel streams or layers to a single UE 101. Multi-layer transmission may be applied for downlink (DL) as well as uplink (UL) transmission.

In a wireless system, link performance can be improved by adapting the transmissions to account for current channel conditions. Schemes for conveying channel information between receiver and transmitter are called closed-loop methods. As shown, the base station 103 includes closed loop preceding and beamforming logic 107 to maximize the signal level. The UE 101 can report the channel state information back to the base station 103 to use for subsequent transmissions. In a beam-forming closed-loop MIMO system, the BS 103 utilizes the channel information to form a beam towards the UE 101 using preceding weights (e.g., a pre-coding matrix extracted from the channel matrix). The base station 103 also includes a scheduler 111, which manages the scheduling of data and control information for transmission to the user equipment 101.

A memory 109 stores the preceding weights that are used for beamforming. Beamforming implies that multiple antennas 105 are used to form the transmission or reception beam; in this way, the signal-to-noise ratio at the UE 101 is increased. This technique can both be used to improve coverage of a particular data rate and to increase the system spectral efficiency. Thus, beamforming can be applied to both to the downlink and the uplink.

The user equipment 101 possesses a feedback module 113 for conveying channel information, such as channel quality information (CQI) and channel state information (CSI), to the base station 103 (i.e., network). As such, a measurement module 115 provides for measuring parameters relating to state of the communication channel (e.g., downlink). This feedback mechanism provides sufficient information to enable the BS 103 to perform the closed-loop transmission on the DL—e.g., quantized channel response or quantized transmit weights). Further, a memory 117 permits storage of preceding weights, as part of the closed-loop MIMO mechanism. The user equipment 101 utilizes a scheduler 119 to schedule transmissions on the uplink. In the MIMO system 100, the UE 101 also has multiple antennas 121 for receiving and transmitting signals.

The base station 103, in an exemplary embodiment, uses OFDM (Orthogonal Frequency Divisional Multiplexing) as the downlink transmission scheme and a single-carrier transmission (e.g., SC-FDMA (Single Carrier-Frequency Division Multiple Access) with cyclic prefix for the uplink transmission scheme. SC-FDMA can be realized also using DFT-S-OFDM principle, which is detailed in 3GGP TR 25.814, entitled “Physical Layer Aspects for Evolved UTRA,” v.1.5.0, May 2006 (which is incorporated herein by reference in its entirety). SC-FDMA, also referred to as Multi-User-SC-FDMA, allows multiple users to transmit simultaneously on different sub-bands.

In an exemplary embodiment, Walsh-Hadamard spreading is used to create orthogonal codes, in which different users can transmit their control channels. Such control channels are multiplexed with the data channels. In this regard, in case of single user multi-stream (i.e., MIMO) transmission, the Walsh-Hadamard spreading is applied in the antenna domain. As a consequence, this approach can achieve transmitter diversity gain provided by the underlying Walsh-Hadamard spreading in the antenna domain. In addition, this approach, according to one embodiment, can use the same spreading in order to improve the detection reliability in case of single user MIMO transmission; such approach can arrange orthogonal control signaling for MIMO application with symbol level multiplexing between control and data channels.

Uplink control signaling, according to 3GGP TR 25.814, is divided into data-associated and data non-data-associated control signaling. Data-associated control signaling is typically transmitted with uplink data transmission. Data non-data-associated control signaling includes, for example, Channel Quality Information (CQI), and thus, can be transmitted independently of uplink data transmission.

In the exemplary scenario of FIG. 1, the system 100 provides for both FDD (Frequency Division Duplex) and TDD (Time Division Duplex) transmission schemes. Due to their difference in frame structure and duplex mode, conventional design for FDD is sub-optimal for TDD, particularly in the area of preceding and beamforming. In FDD, preceding and beamforming are implemented based on the CSI (Channel State Information) feedback from the UE 101. To reduce feedback overhead, the feedback can be quantized and generated per frequency chunk. Each frequency chunk can include several resource units.

In TDD, due to the channel reciprocity of the uplink and the downlink, CSI can be conveyed to the Node B 103 by sending uplink sounding pilots (i.e., training sequences or reference symbols), according to an exemplary embodiment. This approach provides for reduced CSI delay, minimal or no quantization loss and no feedback transmission error. Also, the computation burden needed for computing the beamforming weights is placed at the base station 103, which has greater resources for handling such computations.

As mentioned, the communication system 100, according to one embodiment, is an LTE system, as next described.

FIGS. 2A-2C are diagrams of a communication system having a long-term evolution (LTE) architecture, according to various exemplary embodiments of the invention. In this example, the base station 103 and the UE 101 can communicate in system 200 using Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both the uplink and the downlink can utilize WCDMA. In another exemplary embodiment, uplink utilizes SC-FDMA while downlink utilizes OFDMA. The system 200 provides for uplink transmission that can allow for power-efficient UE transmission to maximize coverage by utilizing single-carrier frequency-division multiple access with dynamic bandwidth. The system 200 can adopt OFDM for broadcast services, especially the services the information is transmitted from several (synchronized) base stations to UEs 101.

The MME (Mobile Management Entity)/serving gateways 201 are connected to the eNBs 103 in a full or partial mesh configuration using tunneling over a packet transport network (not shown). Although shown as a single component, the MME and the serving gateway 201 can be implemented as separate components, as later described. Exemplary functions of the MME/Serving GW 201 include distribution of paging messages to the eNBs 103, IP header compression, termination of U-plane packets for paging reasons, and switching of U-plane for support of UE mobility. Since the MME/Serving GW 201 serve as a gateway to external networks, e.g., the Internet or private consumer networks 203, the GWs 201 include an Access, Authorization and Accounting system (AAA) 205 to securely determine the identity and privileges of a user and to track each user's activities.

As seen in FIG. 2B, the eNB 103 utilizes an E-UTRA (Evolved Universal Terrestrial Radio Access) (user plane, e.g., RLC (Radio Link Control) 207, MAC (Media Access Control) 209, and PHY (Physical) 211, a PDCP (Packet Data Convergence Protocol) 212, and a control plane (e.g., Radio Resource Control (RRC) 213). The eNB 103 also includes the following functions: Inter Cell RRM (Radio Resource Management) 215, RB (Radio Bearer) Control 217, Connection Mobility Control 219, Radio Admission Control 221, eNB Measurement Configuration and Provision 223, and Dynamic Resource Allocation (Scheduler) 225.

The eNB 103 communicates with the MME 201a and serving gateway 201b via an SI interface. The MME 201a provides a NAS security function 227, an Idle State Mobility Handling function 229, as well as a SAE (System Architecture Evolution) Bearer Control 229. The serving gateway 201b has a mobility anchoring function 231. The gateway 201b has connectivity to a data network 235, such as the global Internet.

In FIG. 2C, a 3GPP system 240 supports a multi-access core network, including GERAN (GSM/EDGE radio access) 241, UTRAN 243, E-UTRAN 245 and non-3GPP (not shown) based access networks. This architecture provides separation of the control-plane functionality (as provided by MME 247) from the bearer-plane functionality (provided by serving gateway 249); an open interface S11 is defined between these two network entities 247 and 249.

Thus, service providers have the capability to specify topological locations of the serving gateways 249 independently from the locations of MMEs 247 to optimize network performance.

As seen in FIG. 2C, the E-UTRAN (e.g., eNB) 245 interfaces with UE 101 via LTE-Uu. The E-UTRAN 245 supports LTE air interface and includes functions for radio resource control (RRC) functionality corresponding to the control plane MME 247. The E-UTRAN 245 also performs the following functions: radio resource management, admission control, scheduling, enforcement of negotiated uplink (UL) QoS (Quality of Service), cell information broadcast, ciphering/deciphering of user, compression/decompression of down link (DL) and UL user plane packet headers, and Packet Data Convergence Protocol (PDCP). The MME 247 is responsible for managing mobility of the UE 101 (e.g., enforcing roaming restrictions), as well as paging procedure (e.g., retransmissions). The MME 247 is involved in the bearer activation/deactivation process and selects the serving gateway 249 for the UE 101. The MME 247 is also responsible for performing authorization of the UE 101 and determining the service provider's Public Land Mobile Network (PLMN).

The MME 247 also provides the control plane function for mobility between LTE and 2G/3G access networks with the S3 interface terminating at the MME 247 from the SGSN (Serving GPRS Support Node) 251. The SGSN 251 is responsible for the delivery of data packets from and to the mobile stations within its geographical service area. The functions of the SGSN 251 include packet routing and transfer, mobility management, logical link management, and authentication and billing.

The S6a interface enables transfer of subscription and authentication data for authenticating/authorizing user access to the evolved system (AAA interface) between the MME 247 and a HSS (Home Subscriber Server) 253. The S10 interface between MMEs 247 provides MME relocation and MME 247 to MME 247 information transfer.

The serving gateway 249 is the node that terminates the interface towards the E-UTRAN 245 via S1-U. The S1-U interface provides a per bearer user plane tunneling between the E-UTRAN 245 and serving gateway 249. It contains support for path switching during handover between eNBs 245. The S4 interface provides the user plane with related control and mobility support between SGSN 251 and the 3GPP anchor function of the serving gateway 249. The S12 is an interface between UTRAN 243 and serving gateway 249.

A Packet Data Network (PDN) gateway 255 provides connectivity to the UE 101 to external packet data networks. The PDN gateway 255 performs policy enforcement, packet filtering for each user, charging support, lawful interception and packet screening. The PDN gateway 255 additionally serves as the anchor for mobility between 3GPP and non-3GPP technologies, such as WiMax and 3GPP2 (CDMA IX and EvDO (Evolution Data Only)). The S7 interface provides transfer of QoS policy and charging rules from PCRF (Policy and Charging Role Function) 257 to Policy and Charging Enforcement Function (PCEF) in the PDN gateway 255. The SGi interface is the interface between the PDN gateway 255 and a packet data network 259 (e.g., supporting the operator's IP services). The packet data network 259 may be an operator external public or private packet data network or an intra operator packet data network, e.g., for provision of IMS (IP Multimedia Subsystem) services. Rx+ is the interface between the PCRF and the packet data network 259.

The above LTE architecture is more described in TR 23.882, entitled “3GPP System Architecture Evolution (SAE): Report on Technical Options and Conclusions,” and 3GPP TR 25.813, entitled “E-UTRA and E-UTRAN: Radio Interface Protocol Aspects”; which are incorporated herein by reference in their entireties.

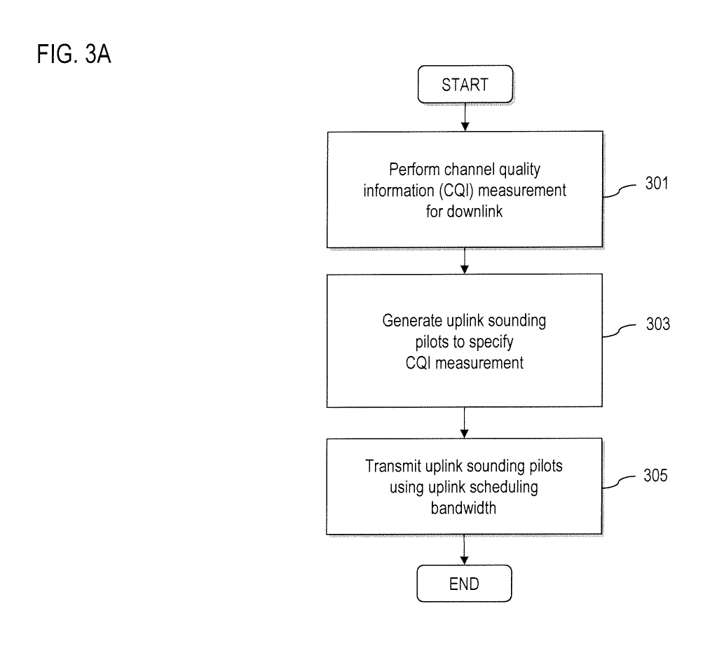

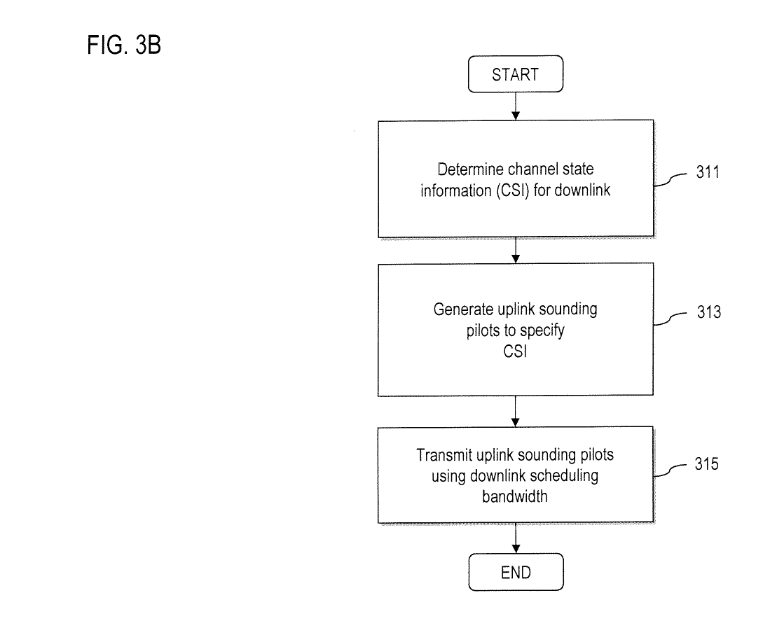

FIGS. 3A and 3B are flowcharts of processes for providing feedback information utilizing, respectively, uplink scheduling bandwidth and downlink scheduling bandwidth, in accordance with an embodiment of the invention. For the purposes of illustration, the feedback mechanism to exchange channel information is described with respect to a TDD system. For TDD system, the transmission of uplink sounding pilots has two primary purposes. The first one is to provide uplink CQI measurement needed for UL scheduling, and the second purpose is to provide DL CSI to aid the DL closed-loop MIMO.

As seen in FIG. 3A, the UE 101 performs CQI measurement for the downlink, per step 301. In step 303, uplink sounding pilots are generated to specify the determined CQI measurement. These uplink sounding pilots are then transmitted in the uplink scheduling bandwidth (step 305).

For the DL MIMO use (shown in FIG. 3B), the UE 101 determines the channel state information (CSI), per step 311. The uplink sounding pilots are generated to signal this CSI, as in step 313. The sounding pilots are then transmitted, as in step 315, in the DL scheduling bandwidth. Traditionally, this transmission encompasses the entire bandwidth. However, if the sounding pilots are sent over the whole bandwidth, the overhead is rather large. Moreover, there are also other constraints that prohibit such transmission over the entire bandwidth—e.g., UE power. Moreover, if the UE 101 is located at a cell edge, for example, the whole-bandwidth transmission of the pilot is critical.

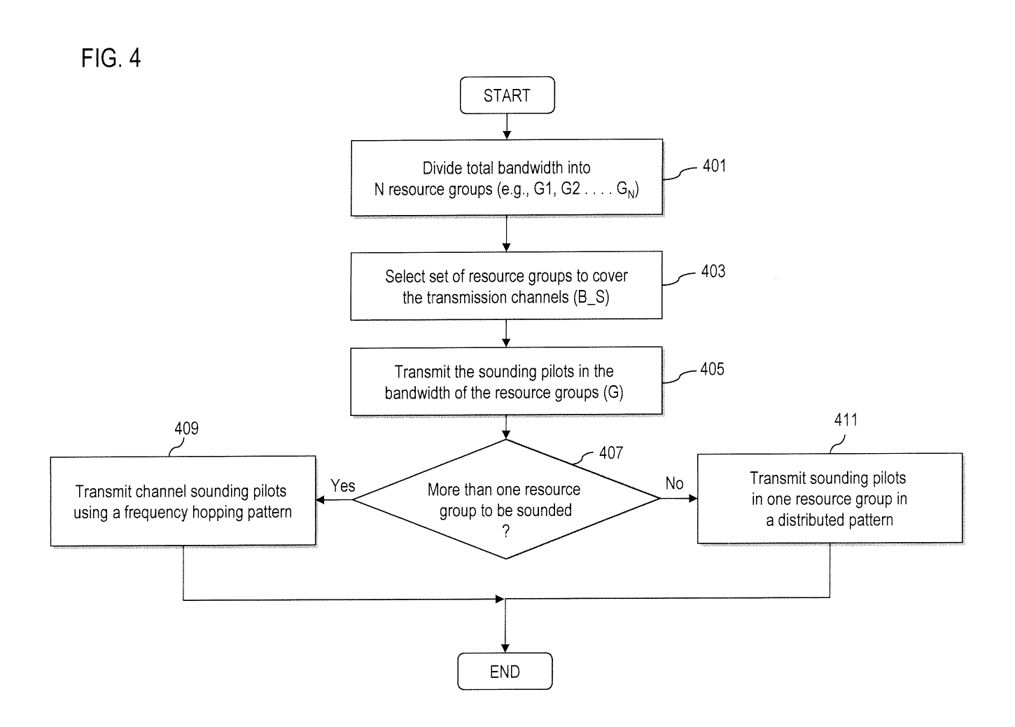

In recognition of this problem, a feedback mechanism is provided, as shown in FIG. 4, that reduces the overhead of uplink sounding in TDD by taking into account the CQI report.

FIG. 4 is a flowchart of a process for uplink sounding pilot transmission, according to an embodiment of the invention. In the downlink, the scheduling and link adaptation are based on the CQI report from the UE 101, and the selection of MIMO parameters is based on the CSI of DL channel, which can be obtained by uplink sounding in TDD. A variety of CQI report mechanisms can be utilized, such as a full CQI report, a Best-M CQI report, or a threshold-based CQI report; in which, the latter two are more attractive since the overhead is smaller. In these schemes, CQI for multiple resource units (RU) can be reported. Scheduling decisions are then made based on the report. The resource units that have reported CQI have a higher probability of being scheduled while the resource unit whose CQI is not reported are not scheduled—even when the CSI or MIMO parameter is available. Therefore, it is of no use for DL scheduling to send the uplink sounding pilots in the bandwidth outside the RUs that are indicated by the CQI report.

To exploit this observation, an UL sounding pilot transmission scheme is proposed, as shown in FIG. 4. In step 401, the total bandwidth of the UL sounding pilots is divided into N resource groups, G₁, G₂ , . . . , and GN. Assuming B_S denotes the total bandwidth of UL sounding pilots, then B_S is determined by the UL scheduling bandwidth B_UL and the DL bandwidth of CQI report B_CQI. B_CQI is the span of the RUs which are indicated in the CQI report and represents the bandwidth on which the DL is to be scheduled:

B_{—}S=B_{—}UL+B_{—}CQI.

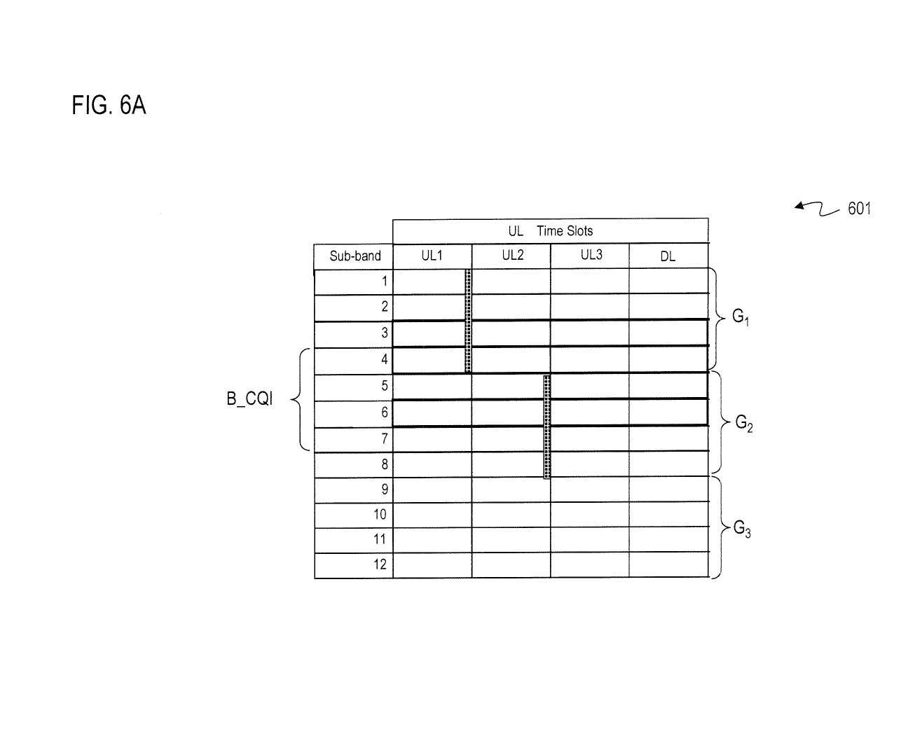

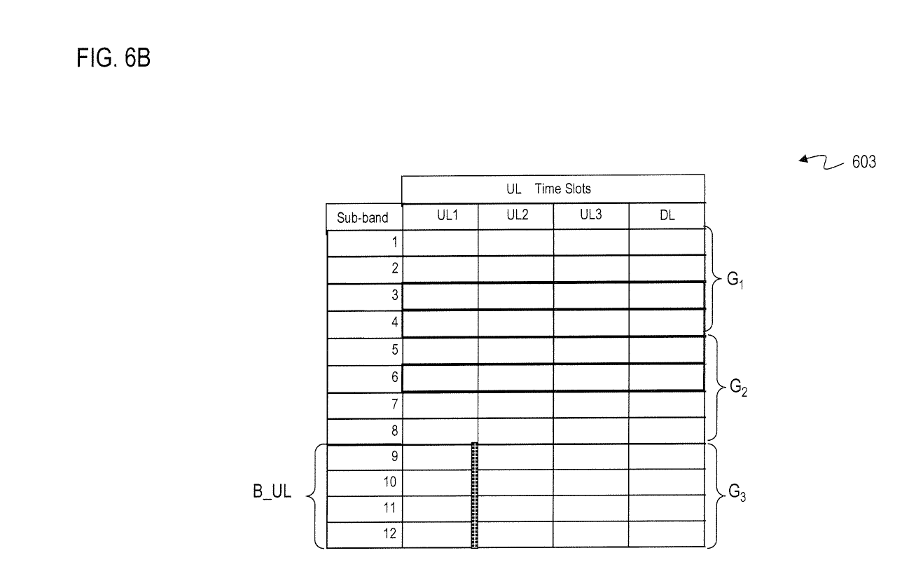

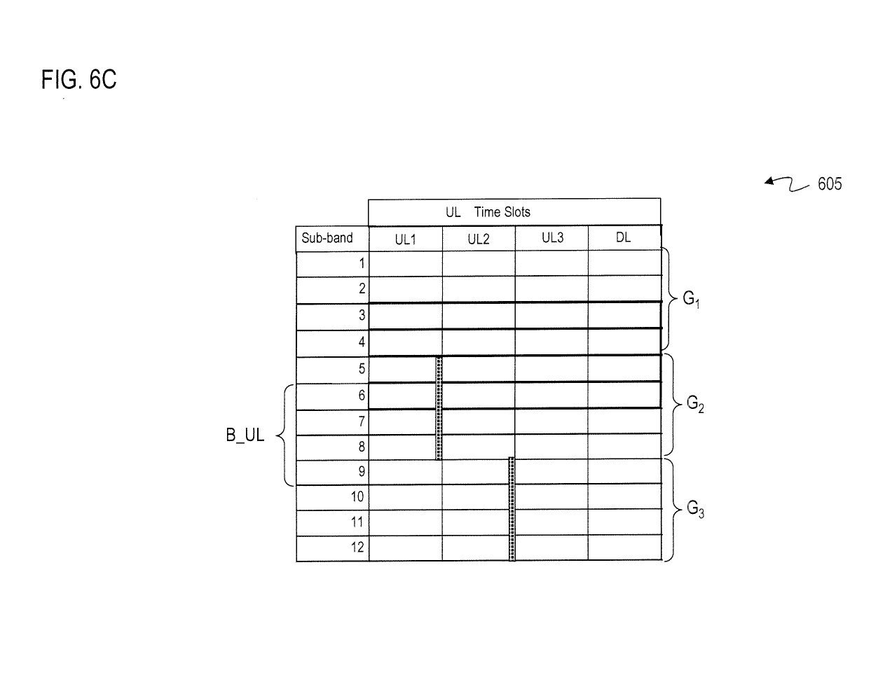

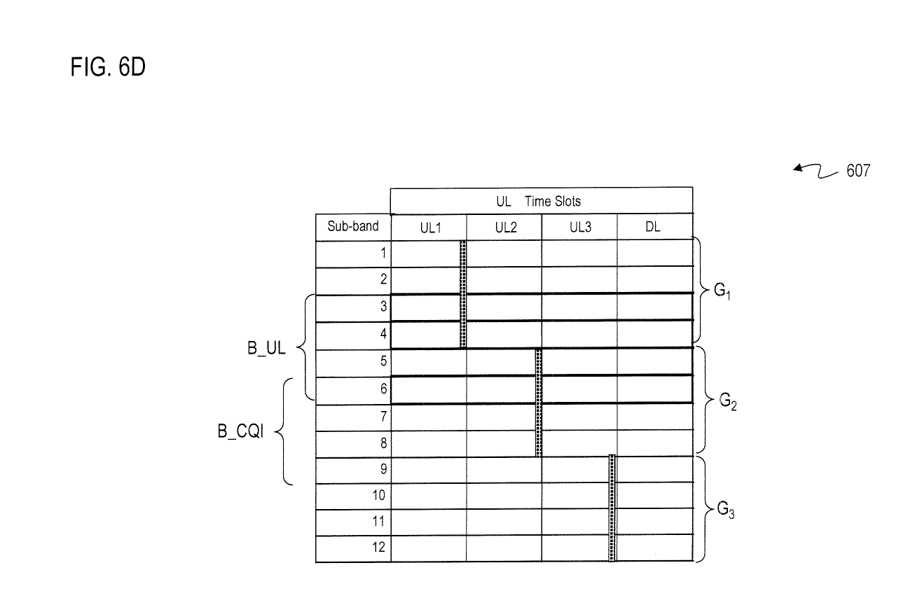

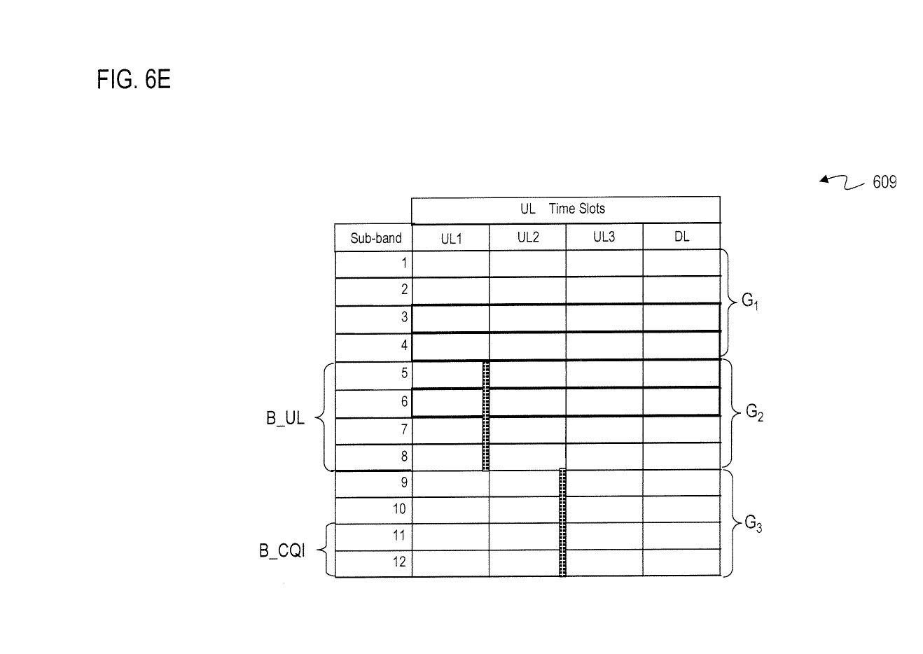

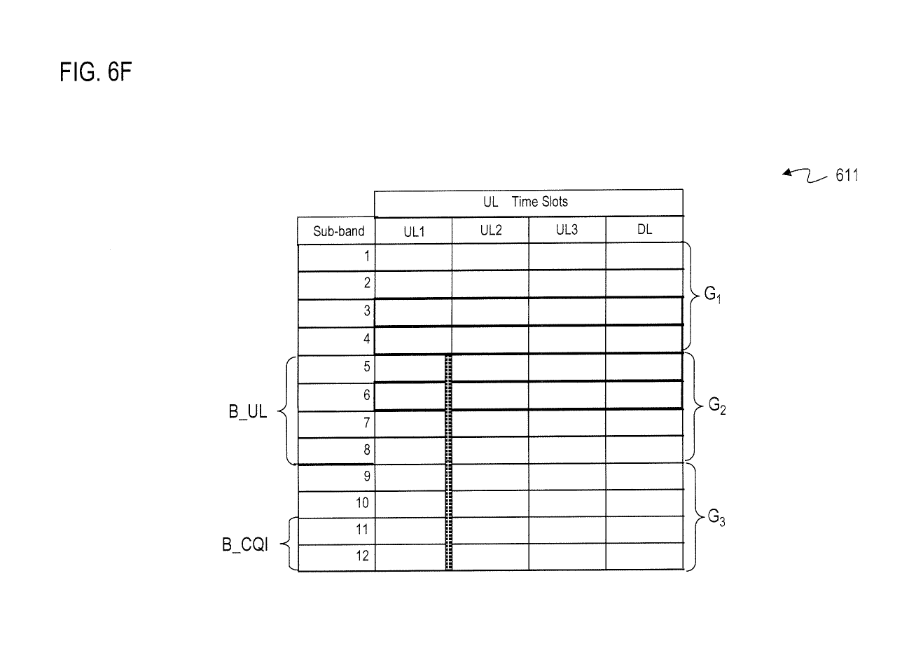

In step 403, a set of resource groups that can cover the total bandwidth (B_S) is selected (the set is denoted as G). Next, the uplink sounding pilots are transmitted, per step 405, in the bandwidth of G. According to one embodiment, the transmission of the sounding pilots is in a frequency hopping pattern, if more than one resource group G is to be sounded (as in steps 407 and 409). In each UL sub-frame the sounding pilots are transmitted in one (or more) resource group of G. By way of example, the sounding pilot occupies one of a Long Block in an UL sub-frame. It is noted that if more than one group needs to be sounded at a time, a larger repetition factor (RF) is used (as shown in FIG. 6F). When one G per slot is sounded, a small RPF attends, while sounding more than one G per slot entails a higher RPF.

In step 411, the sounding pilots are transmitted in a distributed pattern in each resource group. If more than one UE 101 needs to transmit in the same resource group, then frequency division multiplexing (FDM) or code division multiplexing (CDM) can be utilized.

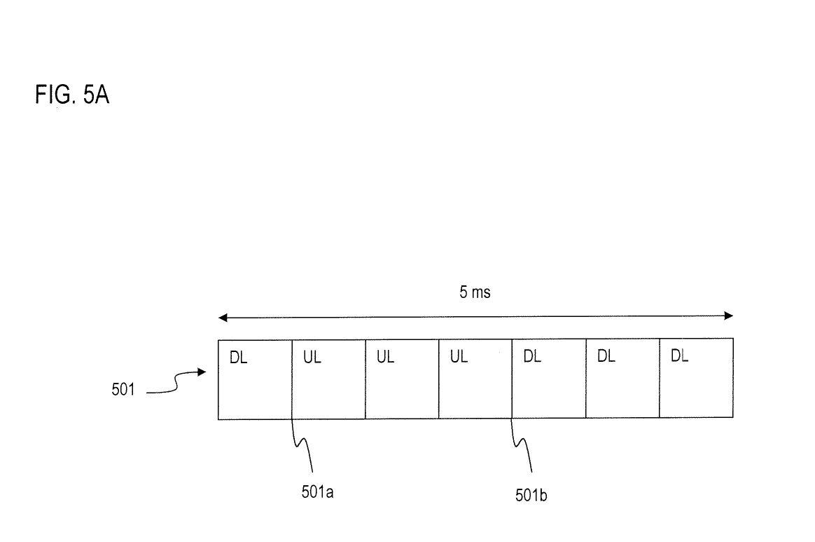

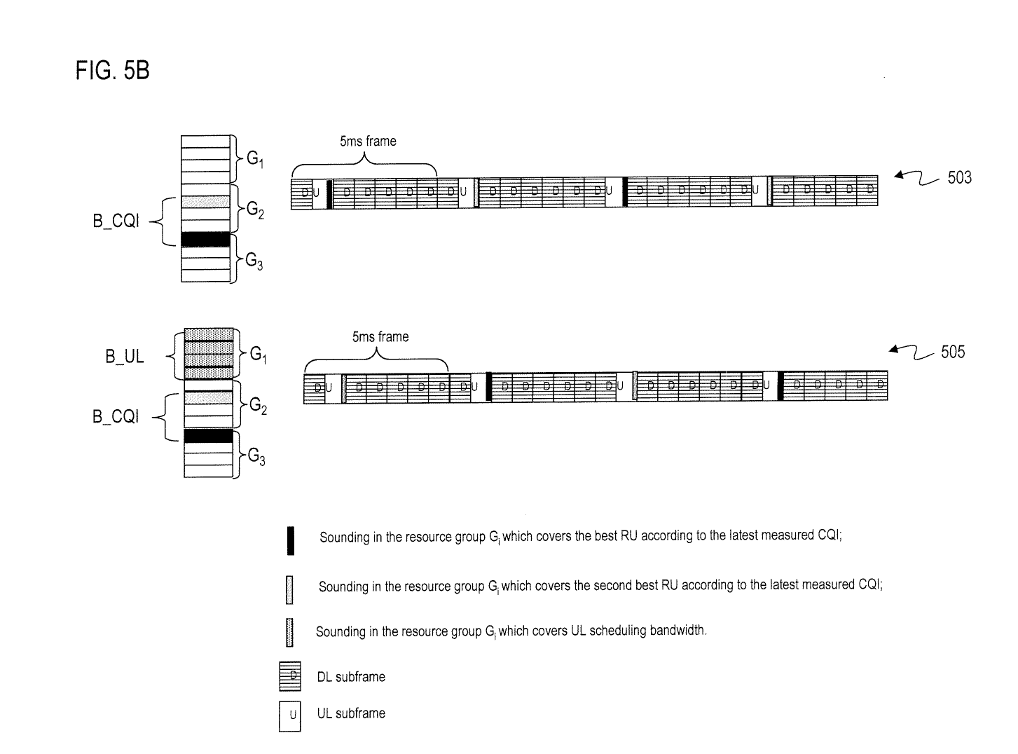

FIGS. 5A and 5B are diagrams of frame structures for uplink sounding pilot transmission, in accordance with certain embodiments of the invention. As seen in FIG. 5A, a frame structure represents a Low Chip Rate —Time Division Duplex (LCR-TDD) sub-frame 501. By way of example, the length of the sub-frame is 5 ms. A frame structure includes two sub-frames—i.e., 10 ms frame length. In this example, seven time slots are provided for uplink and downlink traffic. The first slot is allocated for the downlink, and the second slot for the uplink. Additionally, the next two slots are designated for the uplink, and the last three time slots for the downlink. Between each time slot that transition from uplink to downlink (and vice versa), a switching point (e.g., 501a and 501b) is provided. Thus, two switching points 501a and 501b exist in the 5 ms sub-frame 501. The LCR-TDD sub-frame is more fully described in which is detailed in 3GGP TR 25.937, entitled “Low Chip Rate TDD LUB/LUR Protocol Aspects,” v4.1.0 (which is incorporated herein by reference in its entirety).

As shown in FIG. 5B, an exemplary frame 503 depicts a scenario in which only DL traffic exists. The CQI is reported in a period of, for instance, 10 ms or longer. The best resource unit is in G₃, with the second best being G₂.

Exemplary frame 505 provides a situation in which the B_UL and B_CQI do not overlap. The CQI is reported in a period of 10 ms, for example. As with the previous example, the best resource unit is in G₃ and the second best is in G₂.

FIGS. 6A-6F are diagrams of exemplary uplink sounding pilot patterns, according to various embodiments of the invention. By way of example, a LCR-TDD (low Chip Rate)-(Time Division Duplex) frame structure (also denoted as “TDD Frame Structure 2”), as in FIG. 5A, is utilized. Also, the bandwidth is divided into three resource groups (e.g., N=3), G₁, G₂ and G₃.

In FIG. 6A, it is assumed that there is only DL data transmission and no UL data transmission in pattern 601. Consequently, B_S=B_CQI, and because B_CQI spans over both G₁ and G₂, G={G₁,G₂} results. The sounding pilots are transmitted in a frequency hopping pattern: G₁ is sounded in the first UL time slot, while G₂ in the second UL time slot.

In FIGS. 6B and 6C with patterns 603 and 605, it is assumed that there is no DL data transmission. In such a case, the B_S=B_UL, with G={G₃} in pattern 603 and G={G₂, G₃} in pattern 605.

In FIGS. 6D and 6E, it is assumed that there are both DL and UL data transmission, hence B_S=B_UL+B_CQI. In pattern 607 of FIG. 6D, G={G₁,G₂,G₃}, and G={G₂,G₃} associated with pattern 609 (FIG. 6E).

As mentioned above, the repetition factor (RF) can be larger such that sounding can be performed in consecutive time slots if more than one resource groups are involved, as seen in FIG. 6F. The RPF represents the distance between the subcarriers of the sounding signal. For example, RPF of 1 can signify that all subcarriers are to be used, while RPF of 2 can indicate that every second subcarrier is used.

In the above examples (FIGS. 6A-6F), it can be seen that the sounding bandwidth can be 1/N, 2/N . . . , N/N of the whole bandwidth.

For the case of LCR-TDD frame structure with only one UL subframe, if G encompasses multiple resource groups, then the sounding pilots can be transmitted in the resource group which covers the best RU if the UE 101 has only DL traffic. Alternatively, the sounding pilots can be transmitted in the resource group covering the best RU and the resource group covering the UL scheduling bandwidth if the UE 101 has both DL and UL traffic.

As mentioned, the uplink sounding pilot pattern aids the closed-loop precoding and beamforming in TDD. This approach can be applied to both Low Chip Rate (LCR) and Generic frame structures (also denoted as “TDD Frame Structure 1”) of an LTE TDD system, and can support both UL scheduling and the DL MIMO parameter selection. Additionally, this arrangement accounts for the CQI report bandwidth, thereby reducing overhead for providing channel feedback. In addition, since the transmission of the sounding pilots only in one resource group per sub-frame, the energy per subcarrier can be guaranteed to get good estimation performance. Furthermore, the transmission pattern can be distributed in each resource group, thereby enabling use of FDM and CDM for different UE's pilot transmission.

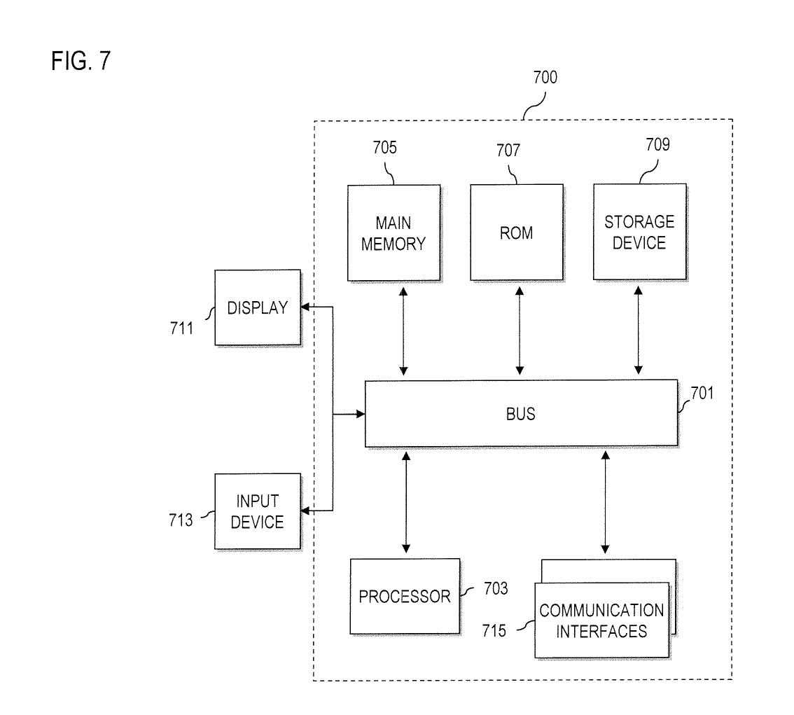

One of ordinary skill in the art would recognize that the processes for providing channel feedback may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 7.

FIG. 7 illustrates exemplary hardware upon which various embodiments of the invention can be implemented. A computing system 700 includes a bus 701 or other communication mechanism for communicating information and a processor 703 coupled to the bus 701 for processing information. The computing system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computing system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computing system 700 may be coupled via the bus 701 to a display 711, such as a liquid crystal display, or active matrix display, for displaying information to a user. An input device 713, such as a keyboard including alphanumeric and other keys, may be coupled to the bus 701 for communicating information and command selections to the processor 703. The input device 713 can include a cursor control, such as a mouse, a trackball, or cursor direction keys, for communicating direction information and command selections to the processor 703 and for controlling cursor movement on the display 711.

According to various embodiments of the invention, the processes described herein can be provided by the computing system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 700 also includes at least one communication interface 715 coupled to bus 701. The communication interface 715 provides a two-way data communication coupling to a network link (not shown). The communication interface 715 sends and receives electrical, electromagnetic, or optical signals that carry digital data streams representing various types of information. Further, the communication interface 715 can include peripheral interface devices, such as a Universal Serial Bus (USB) interface, a PCMCIA (Personal Computer Memory Card International Association) interface, etc.

The processor 703 may execute the transmitted code while being received and/or store the code in the storage device 709, or other non-volatile storage for later execution. In this manner, the computing system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

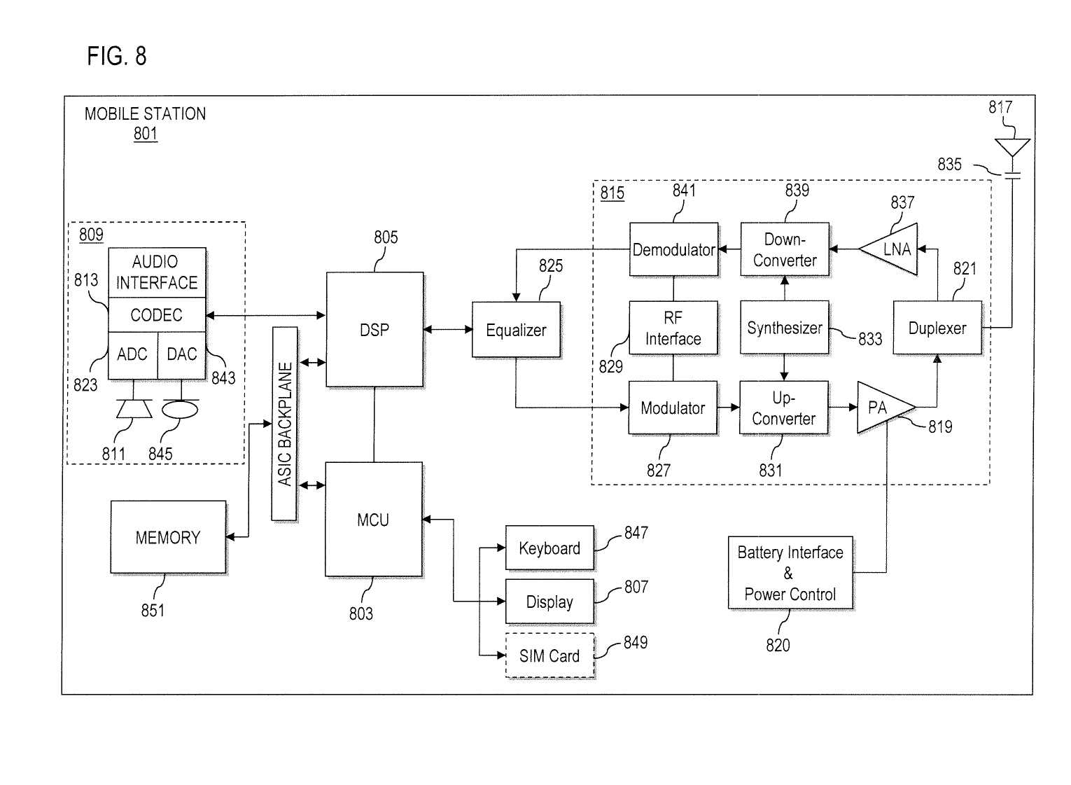

FIG. 8 is a diagram of exemplary components of a mobile station (e.g., handset) capable of operating in the system of FIG. 1, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., systems of FIG. 7A or 7B), via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
partitioning a bandwidth into one or more resource groups corresponding to one or more resource units; and
designating one or more of the partitions for transmission of a plurality of uplink pilots that specify channel information for the corresponding resource units.

2. A method according to claim 1, further comprising:
determining a measurement value relating to channel state information for uplink scheduling, wherein the channel information includes the determined measurement value.

3. A method according to claim 1, wherein the channel information includes channel state information for downlink scheduling to assist with a downlink closed-loop multiple input multiple output (MIMO) procedure.

4. A method according to claim 1, further comprising:
transmitting the uplink pilots using a portion of the bandwidth, the portion being a sum of the designated partitions.

5. A method according to claim 4, wherein the uplink pilots are transmitted according to a time division duplex scheme.

6. A method according to claim 4, wherein the uplink pilots are transmitted in one of the resource groups per uplink subframe.

7. A method according to claim 1, further comprising:
transmitting a report specifying the channel information.

8. A method according to claim 1, wherein the channel information is used to assist with closed-loop preceding and beamforming.

9. A method according to claim 1, wherein the uplink pilots are associated with a first user equipment and constitute a first set of uplink pilots, and a second set of uplink pilots is associated with a second user equipment, wherein the sets of uplink pilots are transmitted according to a frequency division multiplexing (FDM) scheme or a code division multiplexing (CDM) scheme.

10. A method according to claim 1, wherein the bandwidth corresponds to a communication link that is established over a radio network.

11. A method according to claim 10, wherein the radio network is compliant with a long term evolution (LTE)-compliant architecture.

12. An apparatus comprising:
a processor configured to partition a bandwidth into one or more resource groups corresponding to one or more resource units,
wherein the processor is further configured to designate one or more of the partitions for transmission of a plurality of uplink pilots that specify channel information for the corresponding resource units.

13. An apparatus according to claim 12, further comprising:
a measurement module configured to determine a measurement value relating to channel state information for uplink scheduling, wherein the channel information includes the determined measurement value.

15. An apparatus according to claim 12, wherein the channel information includes channel state information for downlink scheduling to assist with a downlink closed-loop multiple input multiple output (MIMO) procedure.

16. An apparatus according to claim 12, further comprising:
a transceiver configured to transmit the uplink pilots using a portion of the bandwidth, the portion being a sum of the designated partitions.

17. An apparatus according to claim 16, wherein the uplink pilots are transmitted according to a time division duplex scheme.

18. An apparatus according to claim 16, wherein the uplink pilots are transmitted in one of the resource groups per uplink subframe.

19. An apparatus according to claim 12, wherein the transceiver is further configured to transmit a report specifying the channel information.

20. An apparatus according to claim 12, wherein the channel information is used to assist with closed-loop preceding and beamforming.

21. An apparatus according to claim 12, wherein the uplink pilots are associated with a first user equipment and constitute a first set of uplink pilots, and a second set of uplink pilots is associated with a second user equipment, wherein the sets of uplink pilots are transmitted according to a frequency division multiplexing (FDM) scheme or a code division multiplexing (CDM) scheme.

22. An apparatus according to claim 12, wherein the bandwidth corresponds to a communication link that is established over a radio network.

23. An apparatus according to claim 22, wherein the radio network is compliant with a long term evolution (LTE)-compliant architecture.

24. A method comprising:
receiving one or more uplink pilots from a user equipment, wherein the uplink pilots specify channel information for a plurality of resource units; and
partitioning a channel bandwidth into a plurality of resource groups corresponding to the resource units, wherein the partitions are utilized for transmission of the uplink pilots.

25. A method according to claim 24, wherein the uplink pilots include a measurement value, determined by the user equipment, relating to channel state information for uplink scheduling, wherein the channel information includes the determined measurement value.

26. A method according to claim 24, wherein the channel information includes channel state information for downlink scheduling to assist with a downlink closed-loop multiple input multiple output (MIMO) procedure.

27. A method according to claim 24, wherein the uplink pilots are transmitted using a portion of the bandwidth that is a sum of the designated partitions.

28. A method according to claim 24, wherein the channel information is used to assist with closed-loop preceding and beamforming.

29. A method according to claim 24, wherein the uplink pilots are associated with the user equipment and constitute a first set of uplink pilots, and a second set of uplink pilots is associated with another user equipment, wherein the sets of uplink pilots are transmitted according to a frequency division multiplexing (FDM) scheme or a code division multiplexing (CDM) scheme.

30. A method according to claim 24, wherein the bandwidth corresponds to a communication link that is established over a radio network that is compliant with a long term evolution (LTE)-compliant architecture.

31. An apparatus comprising:
a transceiver configured to receive one or more uplink pilots from a user equipment, wherein the uplink pilots specify channel information for a plurality of resource units; and
a processor configured to partition a channel bandwidth into a plurality of resource groups corresponding to the resource units, wherein the partitions are utilized for transmission of the uplink pilots.

32. An apparatus according to claim 31, wherein the uplink pilots include a measurement value, determined by the user equipment, relating to channel state information for uplink scheduling, wherein the channel information includes the determined measurement value.

33. An apparatus according to claim 31, wherein the channel information includes channel state information for downlink scheduling to assist with a downlink closed-loop multiple input multiple output (MIMO) procedure.

34. An apparatus according to claim 31, wherein the uplink pilots are transmitted using a portion of the bandwidth that is a sum of the designated partitions.

35. An apparatus according to claim 31, wherein the channel information is used to assist with closed-loop precoding and beamforming.

36. An apparatus according to claim 31, wherein the uplink pilots are associated with a first user equipment and constitute a first set of uplink pilots, and a second set of uplink pilots is associated with a second user equipment, wherein the sets of uplink pilots are transmitted according to a frequency division multiplexing (FDM) scheme or a code division multiplexing (CDM) scheme.

37. An apparatus according to claim 31, wherein the bandwidth corresponds to a communication link that is established over a radio network.

38. An apparatus according to claim 31, wherein the radio network is compliant with a long term evolution (LTE)-compliant architecture.
